(19) United States
(12) Patent Application Publication
(10) Pub. No.: US 2008/0039110 A1
(43) Pub. Date: Feb. 14, 2008

(54) METHOD FOR DYNAMIC RESOURCE ALLOCATION IN MOBILE COMMUNICATION SYSTEM

(75) Inventors: Nam-Gi KIM, Suwon-si (KR); Jae-Hee Cho, Seoul (KR); Jung-Je Son, Seongnam-si (KR); Min-Hee Cho, Suwon-si (KR); Jae-Hyuk Jang, Daegu-city (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/836,985

(22) Filed: Aug. 10, 2007

(30) Foreign Application Priority Data
Aug. 11, 2006 (KR) 10-2006-76111

(51) Int. Cl. H04Q 7/20; H04B 7/00; H04L 12/28

(52) U.S. Cl. 455/452.1; 370/310; 370/431; 455/450

(57) ABSTRACT

A method for dynamic resource allocation in a mobile communication system is provided. The resource allocation method includes allocating a resource to a mobile station by selectively using a first resource allocation scheme or a second resource allocation scheme, determining information fields corresponding to a used resource allocation scheme and values of the information fields, and transmitting the determined information fields to the mobile station. Through the efficient resource allocation, the performance of wireless communication system can be improved.

### PRIORITY

This application claims the benefit under 35 U.S.C. §119(a) of a Korean patent application filed in the Korean Intellectual Property Office on Aug. 11, 2006 and assigned Serial No. 2006-76111, the entire disclosure of which is hereby incorporated by reference.

### BACKGROUND OF THE INVENTION

1. Field of the Invention:

The present invention relates generally to a mobile communication system. More particularly, the present invention relates to a method for dynamic resource allocation in a mobile communication system.

2. Description of the Related Art:

In a mobile communication system, wireless resource allocation is performed for implementing communications between mobile stations. Quantities of wireless resources allocated to a mobile station dynamically change according to a channel state or a data traffic rate required. Since the wireless resources are limited in a wireless communication system, system performance is determined depending on how efficiently the wireless resources are distributed. That is, performance of the wireless communication system is determined by various parameters, including a resource allocation method, an allocation quantity of resource and so on. Nowadays, various wireless resource allocation techniques are being proposed for attaining enhanced system performance.

An example of such wireless resource allocation techniques is a periodic resource allocation scheme, which will be described with reference to FIG. 1.

FIG. 1 illustrates a conventional periodic wireless resource allocation scheme.

Referring to FIG. 1, MAP Information Elements (MAP IEs) in the k^{th} and (k+1)^{th} frames indicate data burst regions for a mobile station 1 (MS 1) and a mobile station 2 (MS 2), respectively. Accordingly, the MAP IEs for indicating the data burst regions for the MS 1 and MS 2 are not necessary in the (k+2)^{th} frame.

As described above, according to the proposed periodic wireless resource allocation scheme, a mobile station receives, in a single frame, information about wireless resources allocated during multiple frame durations. Thus, the MAP overhead can be reduced, compared to existing resource allocation schemes in which the MAP overhead was used in transmitting information about wireless resources allocated on a frame-by-frame basis.

However, if the mobile station requests for a larger allocation quantity of a wireless resource than an initial allocation quantity, a fragmentation phenomenon of wireless resources may occur. Meanwhile, if the mobile station requests for a smaller allocation quantity of a wireless resource than an initial allocation quantity, any additional wireless resource allocated to the mobile station would be wasted.

### SUMMARY OF THE INVENTION

An aspect of the present invention is to address at least the above-mentioned problems and/or disadvantages and to provide at least the advantages described below. Accordingly, an aspect of the present invention is to provide a dynamic resource allocation method for efficiently performing wireless resource allocation.

Another aspect of the present invention is to provide a dynamic resource allocation method for minimizing a MAP overhead of a mobile communication system.

According to one aspect of the present invention, a method for allocating resources of a base station in a mobile communication system is provided. The method includes allocating a resource to a mobile station by selectively using a first resource allocation scheme or a second resource allocation scheme, determining information fields corresponding to the resource allocation scheme used and values of the information fields, and transmitting the determined information fields to the mobile station.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 illustrates a conventional periodic wireless resource allocation scheme;

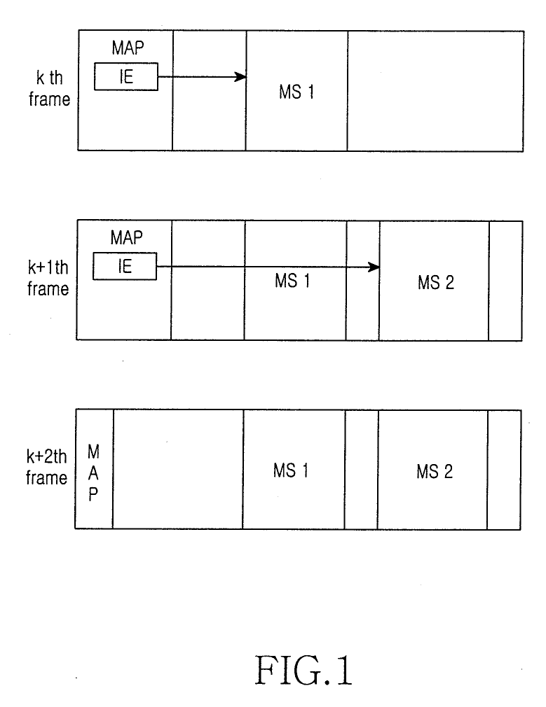

FIG. 2 illustrates a sequential resource allocation scheme according to an exemplary embodiment of the present invention; and

FIG. 3 is a flowchart illustrating a mobile station scheduling process of a base station according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention provides a method for minimizing the waste of resources and the MAP overhead even when quantities of wireless resources allocated to mobile stations in a mobile communication system are dynamically changed. A resource allocation method proposed in an exemplary embodiment of the present invention is a sequential resource allocation scheme.

The sequential resource allocation scheme can be divided into a Full Assignment (FA) and a Differential Assignment (DA). The FA is applied to a mobile station to which a resource is to be allocated for the first time. On the other hand, the DA is applied when there exists a mobile station on which resource allocation has already been performed, a quantity of a resource allocated to the mobile station is to be changed or the resource allocation is to be released.

In an exemplary implementation of the present invention, resource allocation may be performed sequentially in an ascending order of Medium Access Control Identifier (MAC ID) values or Connection ID (CID) values of mobile stations. In the following, an exemplary embodiment of the present invention will be described with reference to a case in which a base station performs resource allocation according to MAC IDs.

The FA may be implemented by a MAP IE including the following fields:

[AllocType+MacID+AllocOffset+AllocLen]

The AllocType field refers to a field used to determine whether resource allocation is based on FA or DA. The MacID field refers to a MAC ID of a mobile station. The AllocOffset and AllocLen fields refer to a start position and a duration length of a wireless resource allocated to the mobile station, respectively.

In the FA, the wireless resource allocation can be performed sequentially in an ascending order of MAC ID values of mobile stations. Accordingly, the base station performs the wireless resource allocation first with priority on a mobile station having a small MAC ID value relative to a mobile station having a large MAC ID value. Of course, according to an exemplary embodiment of the invention, the wireless resource allocation may be performed in an opposite order to the illustrated order. That is to say, the wireless resource allocation can be performed sequentially in a descending order of MAC ID values of mobile stations.

The DA may be implemented by a MAP IE including the following fields:

[AllocType+MacID+Sign+DiffLen]

The AllocType and MacID fields are the same as defined above in the case of the FA. The Sign field indicates whether an allocation quantity of the resource allocated to a mobile station is increased or decreased relative to the quantity of the resource already allocated to the mobile station, as represented by either a plus (+) sign or a minus (−) sign. The DiffLen field indicates an increment or decrement in the quantity of the resource, the increment or decrement depending on the value of the Sign field. Like in the FA, the wireless resource allocation scheme using the DA can also be performed sequentially in an order of MAC ID values of mobile stations.

In the case of the FA, there may be an occurrence in which a first mobile station to which a resource has already been allocated exists and resource allocation has to be newly performed to a second mobile station. In such an instance, the base station compares magnitudes of MAC ID values of the two mobile stations. If the MAC ID value of the first mobile station is smaller than that of the second mobile station as a result of comparison, a resource positioned after the resource having already been allocated to the first mobile station should be allocated to the second mobile station. In other words, a value of AllocOffset of the resource to be allocated to the second mobile station should be larger than that of AllocOffset of the resource having already been allocated to the first mobile station.

However, if the MAC ID value of the first mobile station is larger than that of the second mobile station, the resource positioned before the resource having already been allocated to the first mobile station should be allocated to the second mobile station. Accordingly, the position of the resource having been already allocated to the first mobile station is changed due to the presence of the resource allocated to the second mobile station.

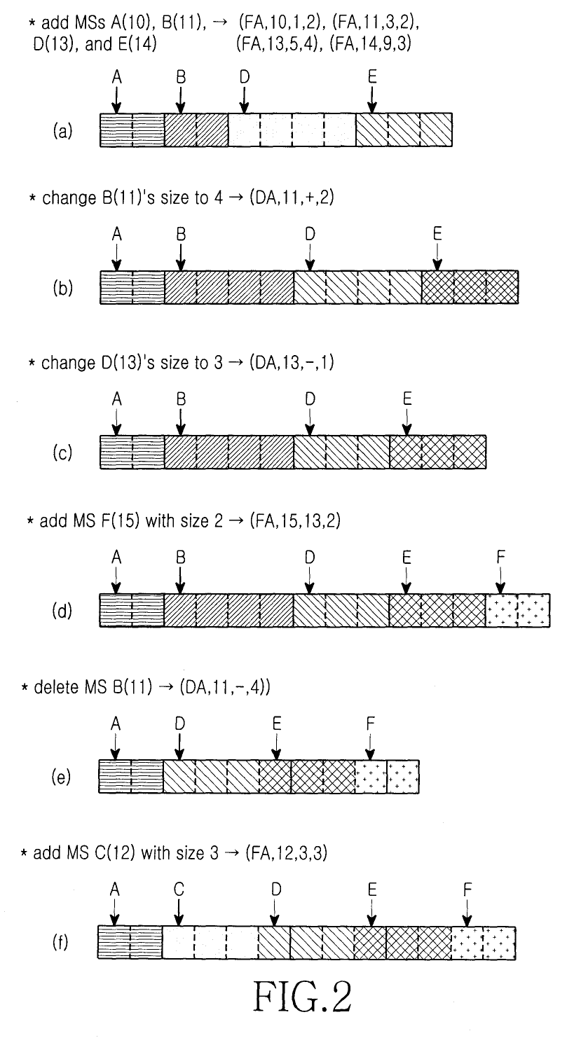

The foregoing description can also be applied to the case of the DA. An exemplary sequential resource allocation scheme using FA and DA will now be described with reference to FIG. 2.

FIG. 2 illustrates a sequential resource allocation scheme according to an exemplary embodiment of the present invention.

In an exemplary implementation of the present invention, a one-dimensional resource allocation scheme considering only one of a time-domain resource and a frequency-domain resource is described. However, the exemplary embodiment of the present invention may be applied to a two-dimensional resource allocation scheme considering both time-domain and frequency-domain resources.

Referring to FIG. 2(a), resource allocation is performed on a plurality of mobile stations, i.e., MS A(MAC ID=10), MS B (MAC ID=11), MS D (MAC ID=13), and MS E (MAC ID=14). As evident from FIG. 2(a), an FA is used in the resource allocation, and the MS A having the smallest MAC ID value, among the plurality of mobile stations, has the highest priority in performing the resource allocation. Accordingly, with regard to the MS A having a value of AllocOffset ‘1’ and a value of AllocLen ‘2’, it is assumed that resources from the first resource to the second resource are allocated to the MS A. Similarly, it is assumed that resources from the third resource to the fourth resource are allocated to the MS B. It is also assumed that resources from the fifth resource to the eighth resource are allocated to the MS D and resources from the ninth resource to the eleventh resource are allocated to the MS E.

FIG. 2(b) illustrates that a quantity of the resource allocated to the MS B is increased by ‘2’. The base station performs DA-based scheduling such that a quantity of the resource allocated to the MS B is increased by ‘2’. Accordingly, AllocOffset values of the MS D and the MS E are both increased by ‘2’ equivalent to the increase in the AllocLen value of the MS B.

FIG. 2(c) illustrates that a quantity of the resource allocated to the MS D is decreased by ‘1’. The base station performs DA-based scheduling such that a quantity of the resource allocated to the MS D is increased by ‘1’. Accordingly, the quantity of the resource allocated to the MS D becomes 3 and the AllocLen value of the MS E is decreased by ‘1’.

FIG. 2(d) illustrates that resource allocation is additionally performed on a new MS F (MAC ID=15). The base station performs resource allocation using FA on the MS F having an AllocLen value of 2 such that resources from the thirteenth resource to the fourteenth resource are allocated to the MS F.

FIG. 2(e) illustrates that resource allocation performed on the MS B is released. The base station performs a resource allocation release process on the MS B using DA and respectively decreases the AllocLen values of the MS D, the MS E and the MS F 2 by ‘4’ corresponding to the AllocLen values of the MS B deleted.

FIG. 2(f) illustrates that resource allocation is additionally performed on a new MS C (MAC ID=12). As shown in FIG. 2(f), an MAC ID value of the MS C is smaller than that of the MS D, meaning that the MS C has a higher priority than the MS D in the resource allocation. The base station allocates to the MS C having an AllocLen value of 3 resources from the third resource to the fifth resource. Accordingly, the AllocOffset values of the MS D, the MS E and the MS F are increased by ‘3’ corresponding to the AllocLen of the MS C newly added.

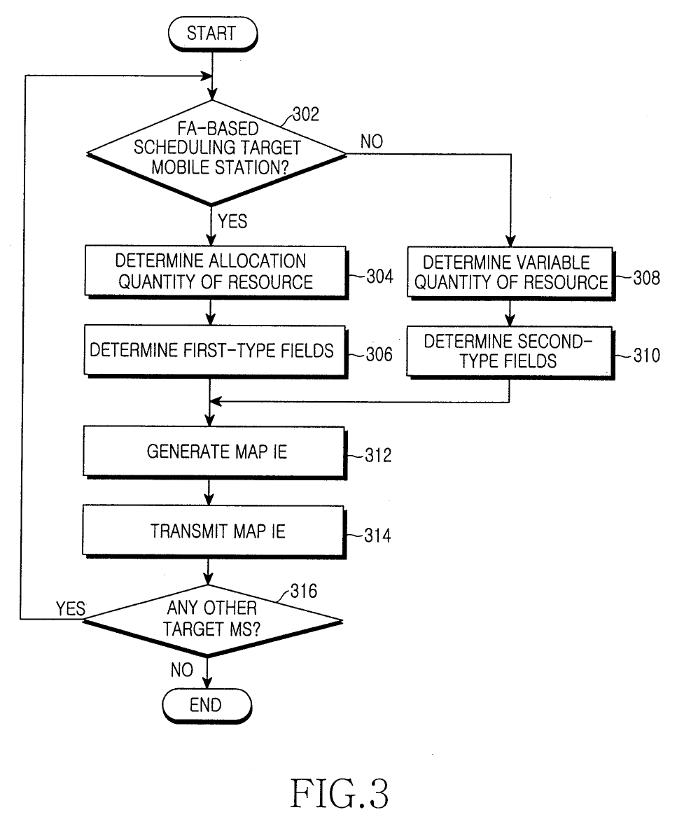

FIG. 3 is a flowchart illustrating a mobile station scheduling process of a base station according to an exemplary embodiment of the present invention.

Referring to FIG. 3, in step 302, the base station determines whether a pertinent mobile station is an FA-based scheduling target mobile station. If the mobile station is the FA-based scheduling target mobile station, in which the case resource allocation is newly performed, the process proceeds to step 304. If the mobile station is not a DA-based scheduling target mobile station, in which the case a resource allocation quantity is to be changed, the process proceeds to step 308.

In step 304, the base station determines a quantity of a resource to be allocated to the FA-based scheduling target mobile station and the process proceeds to step 306. In step 306, the mobile station determines first-type fields for constructing a MAP IE and the process proceeds to step 312. Here, the first-type fields are information fields to be included in the MAP IE in order to perform the FA-based scheduling, such as AllocType, MacID, AllocOffset or AllocLen fields.

Meanwhile, in step 308, the base station determines a variable quantity of resource to be allocated to the DA-based scheduling target mobile station and the process proceeds to step 310. In step 310, the base station determines second-type fields and the process proceeds to step 312. Here, the second-type fields are information fields to be included in the MAP IE in order to perform the DA-based scheduling, such as AllocType, MacID, Sign or DiffLen fields.

In step 312, the base station generates the MAP IE constructed of the first-type fields or the second-type fields and the process proceeds to step 314. In step 314, the base station transmits the generated MAP IE to the mobile station together with a MAP message containing the MAP IE and the process proceeds to step 316. In step 316, the base station determines whether additional scheduling target mobile stations exist. If it is determined that there exist additional scheduling target mobile stations exist, the process returns to step 302 and the steps subsequent to step 302 are then repeated. However, if it is determined that no additional scheduling target mobile station exists, the scheduling process ends.

As described above, according to exemplary embodiments of the present invention, a fragmentation phenomenon of resources and wasteful resource allocation can be prevented even when quantities of resources to be allocated to a mobile station dynamically change in a mobile communication system. In addition, the MAP overhead can be reduced by using a small-quantity resource allocation scheme.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A method for allocating resources in a base station of a mobile communication system, comprising:
allocating a resource to a mobile station by selectively using a first resource allocation scheme or a second resource allocation scheme;
determining information fields corresponding to a used resource allocation scheme and values of the information fields; and
transmitting the determined information fields to the mobile station.

2. The method of claim 1, wherein the first resource allocation scheme is applied to a mobile station to which a resource is allocated for the first time.

3. The method of claim 1, wherein the second resource allocation scheme is applied to a mobile station in which a quantity of the resource previously allocated is changed or a resource allocation release process is performed.

4. The method of claim 1, wherein the information fields corresponding to the first resource allocation scheme comprise:
a first field for indicating that resource allocation is performed by using the first resource allocation scheme;
a second field for determining whether a pertinent mobile station is a scheduling target mobile station; and
a third field for indicating a start position of resource allocation, and a fourth field for indicating a duration length of the resource allocated.

5. The method of claim 1, wherein the information fields corresponding to the second resource allocation scheme comprise:
a fifth field for indicating that resource allocation is performed by using the second resource allocation scheme;
a sixth field for determining whether the pertinent mobile station is a scheduling target mobile station;
a seventh field for indicating whether a resource allocation quantity is increased or decreased; and
an eighth field for indicating an increment or decrement in the resource allocation quantity relative to the quantity of the resource previously allocated.

6. The method of claim 1, wherein the first resource allocation scheme and the second resource allocation scheme perform resource allocation in consideration of a size of a Media Access Control Identifier (MAC ID) value of the mobile station.

7. The method of claim 1, further comprising:
if a first mobile station having the resource previously allocated thereto exists and resource allocation has to be newly performed to a second mobile station by using the first resource allocation scheme, comparing magnitudes of Media Access Control Identifier (MAC ID) values of the first and second mobile stations;
if the MAC ID value of the first mobile station is smaller than that of the second mobile station as a result of comparison, shifting a start position of the resource allocated to the first mobile station to a new position spaced apart from the start position by a duration length corresponding to the quantity of the resource to be allocated to the second mobile station; and
allocating the resource positioned in the start position of the first mobile station, prior to being shifted to the new position, to the second mobile station.

8. A method for allocating resources in a mobile communication system, comprising:
allocating a resource to a mobile station by selectively using a plurality of resource allocation schemes;
determining information fields corresponding to a used resource allocation scheme and values of the information fields;
generating the determined information fields; and
transmitting the generated information fields to the mobile station.

9. The method of claim 8, wherein a first resource allocation scheme is applied to a mobile station to which a resource is allocated for the first time.

10. The method of claim 9, wherein a second resource allocation scheme is applied to a mobile station in which a quantity of the resource previously allocated is changed or a resource allocation release process is performed.

11. The method of claim 10, wherein the information fields corresponding to the first resource allocation scheme comprise;
a first field for indicating that resource allocation is performed by using the first resource allocation scheme;
a second field for determining whether a pertinent mobile station is a scheduling target mobile station;
a third field for indicating a start position of resource allocation; and
a fourth field for indicating a duration length of the resource allocated.

12. The method of claim 10, wherein the information fields corresponding to the second resource allocation scheme comprise:
a fifth field for indicating that resource allocation is performed by using the second resource allocation scheme;
a sixth field for determining whether the pertinent mobile station is a scheduling target mobile station;
a seventh field for indicating whether a resource allocation quantity is increased or decreased; and
an eighth field for indicating an increment or decrement in the resource allocation quantity relative to the quantity of the resource previously allocated.

13. The method of claim 10, wherein the first resource allocation scheme and the second resource allocation scheme perform resource allocation in consideration of a size of a Media Access Control Identifier (MAC ID) value of the mobile station.

14. The method of claim 10, further comprising:
if a first mobile station having the resource previously allocated thereto exists and resource allocation has to be newly performed to a second mobile station by using the first resource allocation scheme, comparing magnitudes of Media Access Control Identifier (MAC ID) values of the first and second mobile stations;
if the MAC ID value of the first mobile station is smaller than that of the second mobile station as a result of comparison, shifting a start position of the resource allocated to the first mobile station to a new position spaced apart from the start position by a duration length corresponding to the quantity of the resource to be allocated to the second mobile station; and
allocating the resource positioned in the start position of the first mobile station, prior to being shifted to the new position, to the second mobile station.
